(19) United States
(12) Patent Application Publication
(10) Pub. No.: US 2009/0029076 A1
(43) Pub. Date: Jan. 29, 2009

(54) Metal-Molded Article Made By Mold Assembly

(75) Inventors: Jan Manda, Toronto (CA); Josef Graetz, Erin (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/829,127

(22) Filed: Jul. 27, 2007

(51) Int. Cl. B32B 1/08; B22D 17/00

(52) U.S. Cl. 428/34.1; 164/113; 164/303

(57) ABSTRACT

Disclosed is, according to an aspect, a metal-molded article, including: (i) a body molded in association with a mold assembly, and (ii) a hollow insert embedded, at least in part, in the body. The body has a light-metal alloy that was injected, under pressure, into the mold assembly.

### TECHNICAL FIELD

The present invention generally relates to, but is not limited to, molding systems, and more specifically the present invention relates to, but is not limited to, (i) a metal-molded article, (ii) a mold for making a metal-molded article.

### BACKGROUND

Examples of known molding systems are (amongst others): (i) the HyPET™ Molding System, (ii) the Quadloc™ Molding System, (iii) the Hylectric™ Molding System, and (iv) the HyMET™ Molding System, all manufactured by Husky Injection Molding Systems (Location: Canada; www.husky.ca).

United States Patent Application Number 2005/0001354 (Inventor: Klocke et al.; Published: 2005 Jan. 6) discloses a process for preparing a composite hollow body article by means of injection molding. The process includes the steps of: (a) providing a hollow body having exterior surfaces and interior surfaces, the interior surfaces of the hollow body defining a hollow interior, the hollow body also having at least one opening which provides fluid communication with the hollow interior thereof, (b) introducing a substantially incompressible fluid into the hollow interior of the hollow body, the hollow interior being substantially filled with the substantially incompressible fluid; and (c) injection molding thermoplastic material onto at least a portion of the exterior surfaces of the hollow body. The object of the present invention is to provide a process for the production of a plastics/metal composite component which consists at least of a hollow body made of metal or plastics material, in which process the hollow body does not become deformed when thermoplastic plastics material is injection molded onto and/or around it. Specifically, paragraph 16 indicates that “the incompressible fluid with which the hollow body is filled according to the invention when the thermoplastic plastics material is injection molded onto or around the hollow body prevents plastic deformation of the hollow body by the injection pressure. The incompressible fluid provides the necessary counter-pressure to the injection pressure. In a preferred embodiment of the process according to the invention, a positive pressure of less than or equal to 130 bar is applied to the incompressible fluid (e.g., a pressure of from 1 bar to 130 bar).” Specifically, paragraph 17 indicates that “the incompressible fluid may be, for example, water, a water/oil mixture, especially an oil-in-water emulsion, a water/glycol mixture or a (mineral) oil. Such fluids are known, for example, as hydraulic fluids of category HFA (oil-in-water emulsions or solutions, which contain more than 80% water), HFB (water-in-oil emulsions having a water content of about 45%) and HFC (polymer/water or water/glycol mixture having a water content of at least 35%). It is additionally possible to use electro-viscous or magneto-viscous fluids.” Specifically, paragraph 21 indicates that the “preferred metals from which the hollow body may be fabricated include steel, nickel, chromium, iron, copper, zinc, titanium, aluminum and magnesium and also alloys of those metals.”

PCT Patent Application Number WO 2005/002825 (Inventor: KLOCKE; Published: 2005 Jan. 13) discloses a method for producing a plastic/metal composite part consisting of at least one metal or plastic hollow body which is provided with at least one aperture and on which injection molding and/or total or partial over-molding with thermoplastic are carried out. The hollow body is entirely filled with an incompressible liquid during injection molding and/or over-molding.

### SUMMARY

The inventors believe they have arrived at an understanding of the problem that is not known and/or understood to persons skilled in the art. In the conventional die-casting processes, a mold core is extracted after a die-casting operation. The mold core is routinely used to form holes or voids in molded parts. Another molding solution uses an expendable core that is disintegrated (or removed) in a post molding operation, and thereby an internal channel may be formed in a molded article. However, to use a high-pressure injection molding process, a necessity to withstand high injection speeds and high pressures (or impacts) creates a series of problems related to the brittle nature of a molded part. A second problem associated with a molded component having a light metal alloy (such as a magnesium alloy) is the increased reaction and resultant corrosion caused by a cooling media in contact with the magnesium alloy. This is a reason for which forced-cooled molded components made out of the magnesium alloy are not seriously considered by designers of molded parts. The nature of the laminar flow associated with a magnesium injection molding process (along with the high level of automation used) may permit opportunities to create more complex parts without significant added cost in the molding operation.

The method proposed by the inventors, includes insertion of a hollow insert (at least one hollow insert) or a collection of hollow inserts (either interconnected or not interconnected) in a mold prior to injection of a metallic alloy (light metal alloy, such as magnesium) into the mold. The hollow insert is permanently over-molded (at least in part). The hollow insert may be made out of a material that is compatible with the light-metal alloy and the cooling media flowing through the hollow insert during the operation. The hollow nature of the hollow insert will allow a broader choice of materials without a negative impact on the weight of the final part.

A technical effect, amongst other technical effects, of the aspects of the present invention is that the hollow insert may be used to perform a function, such as: cooling, heating, weight saving, fluid transfer, improved strength, etc. Also, removal of heat directly from the part being molded during the molding operation may be performed if it is deemed necessary for reducing cycle time of the injection molding system.

According to a first aspect of the present invention, there is provided a metal-molded article, including: a body molded in association with a mold assembly; and a hollow insert embedded, at least in part, in the body, the body having a light-metal alloy that was injected, under pressure, into the mold assembly.

According to a second aspect of the present invention, there is provided a metal-molding process, including: a positioning operation, including positioning a hollow insert in a mold assembly being couplable with an injection metal-molding system; a closing operation, including closing the mold assembly over the hollow insert at least in part; and an injecting operation, including injecting a light-metal alloy into the mold assembly, the light-metal alloy surrounding, at least in part, the hollow insert, and the light-metal alloy forming into a body of a metal-molded article.

According to a third aspect of the present invention, there is provided a mold assembly for molding a metal-molded article, the mold assembly including: a mold portion, having: a molding surface configured to mold, at least in part, a body; and an insert locator configured to locate, at least in part, a hollow insert, the hollow insert to be embedded, at least in part, in the body, the body having a light-metal alloy that was injected, under pressure, into the mold assembly.

### DESCRIPTION OF THE DRAWINGS

A better understanding of the non-limiting embodiments of the present invention (including alternatives and/or variations thereof) may be obtained with reference to the detailed description of the non-limiting embodiments of the present invention along with the following drawings, in which:

FIG. 1A depicts a mold assembly 20 according to a first non-limiting embodiment;

FIG. 1B depicts the mold assembly 20 of FIG. 1A according to a second non-limiting embodiment, and a hollow insert 100 according to a third non-limiting embodiment;

FIG. 2A depicts the mold assembly 20 FIG. 1A according to a fourth non-limiting embodiment, and a molded article according to a fifth non-limiting embodiment;

FIG. 2B depicts a molding system process 500 according to a sixth non-limiting embodiment;

FIGS. 3A and 3B depict a molded article according to a seventh non-limiting embodiment; and

FIG. 3C depicts a molded article according to an eighth non-limiting embodiment.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### REFERENCE NUMERALS USED IN THE DRAWINGS

The following is a listing of the elements designated to each reference numeral used in the drawings:
metal-molded article, 10
molding surface, 12
mold assembly, 20
mold portion, 22
bore, 30
bore molding surface, 32
mounting hole, 40
boss molding surface, 42
boss, 44
core locator, 52
body, 60
hollow insert, 100
passageway, 101
standoff, 110
insert locator, 112
metal-molding process, 500
positioning operation, 502
closing operation, 504
injecting operation, 506

### DETAILED DESCRIPTION OF THE NON-LIMITING EMBODIMENTS

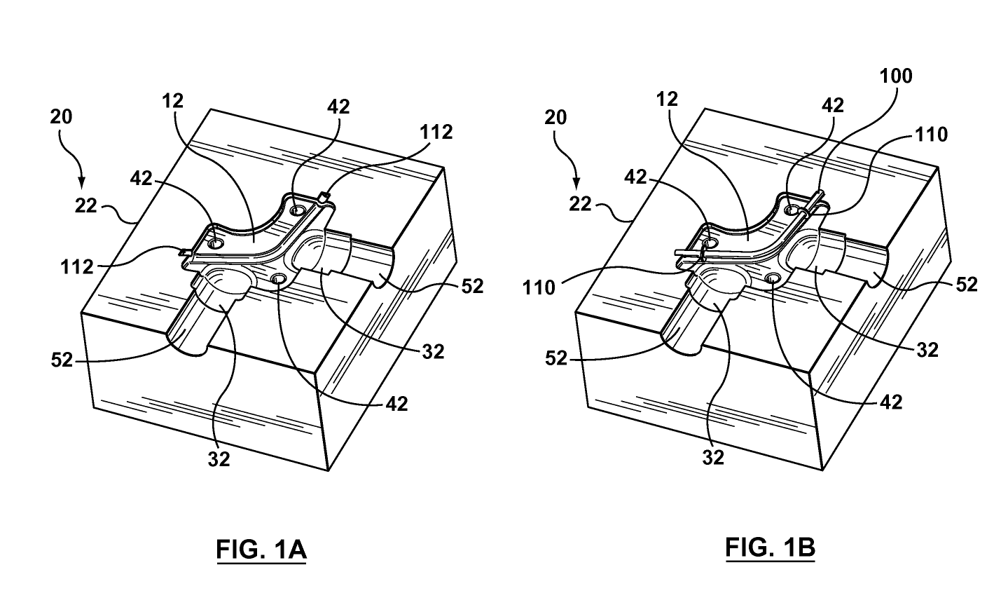

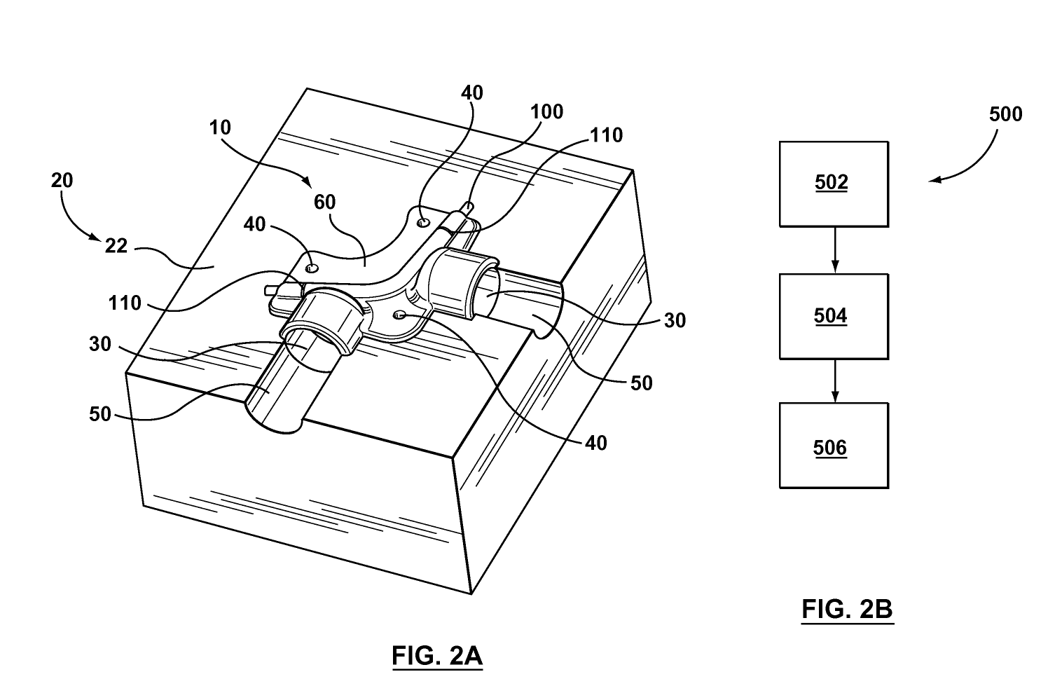

FIG. 1A depicts a mold assembly 20 according to the first non-limiting embodiment. The mold assembly 20, used for molding a metal-molded article 10, includes: (i) a mold portion 22, and (ii) an insert locator 112. The mold portion 22 has a molding surface 12 configured to mold, at least in part, a body 60 (depicted in FIG. 2A). The insert locator 112 is configured to locate, at least in part, a hollow insert 100 (depicted in FIG. 1B) to be embedded, at least in part, in the body 60. The body 60 has a light-metal alloy that was injected, under pressure, into the mold assembly 20.

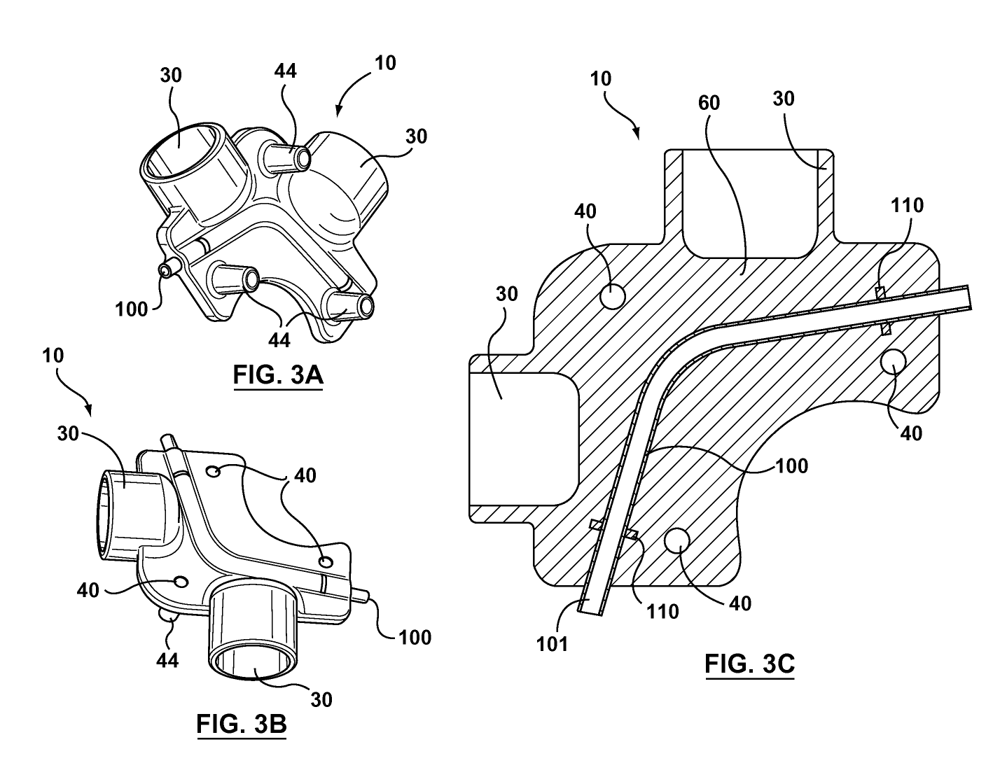

According to variants: the mold portion 22 may include: (i) a boss molding surface 42 configured to locate, at least in part, a boss 44 (depicted in FIG. 3A), (ii) a bore molding surface 32 configured to locate, at least in part, a bore 30 (depicted in FIG. 2A), and/or (iii) a core locator 52 configured to locate, at least in part, a core.

FIG. 1B depicts the mold assembly 20 of FIG. 1A according to the second non-limiting embodiment, and the hollow insert 100 according to the third non-limiting embodiment. Placement of the hollow insert 100 may be done before the mold closes for the injection cycle, preferably by automatic means (robot, etc).

FIG. 2A depicts the mold assembly 20 of FIG. 1A according to the fourth non-limiting embodiment, and a molded article 10 according to the fifth non-limiting embodiment. The metal-molded article 10 includes: (i) a body 60, and (ii) a hollow insert 100. The body 60 is molded in association with a mold assembly 20. The hollow insert 100 is embedded, at least in part, in the body 60. The body 60 has a light-metal alloy (such as magnesium) that was injected, under pressure, into the mold assembly 20.

According to a variant, the hollow insert 100 includes: (i) a tube, (ii) a hollow core, and/or (iii) a network of tubes. According to yet another variant, the light-metal alloy includes a magnesium alloy. Given magnesium's good thermal conductivity, it is in many occasions preferred to plastics in applications where heat removal is a requirement, despite the increased level of complexity posed by magnesium injection molding as compared to plastics. Usually, thermal conduction coupled with natural convection generated at the outside of the part is used to dissipate the heat generated inside casings. Another important feature generated by the magnesium injection process is light-weight components. This is achieved by the low density of the magnesium alloy and a shell design combined with thin wall ribs. The hollow inserts can enhance the light weight requirement in areas where the shell design is not suitable. Providing a liner (that is, a hollow insert) with the desired properties may be an advantage for the parts produced with this method.

FIG. 2B depicts a molding system process 500 according to the sixth non-limiting embodiment. The metal-molding process 500 includes: (i) a positioning operation 502, (ii) a closing operation 504, and (iii) an injecting operation 506. The positioning operation 502 includes positioning the hollow insert 100 of FIG. 1B in the mold assembly 20 of FIG. 1A being couplable with a metal-molding system. The closing operation 504 includes closing the mold assembly 20 over the hollow insert 100 at least in part. The injecting operation 506 includes injecting a light-metal alloy into the mold assembly 20, the light-metal alloy surrounding, at least in part, the hollow insert 100, and the light-metal alloy forms into a body 60 of a metal-molded article 10. According to variants, the hollow insert 100 includes: (i) a tube, (ii) a hollow core, (iii) a network of tubes (either interconnected or not interconnected). According to yet another variant, the light-metal alloy includes a magnesium alloy.

FIGS. 3A and 3B depict the molded article 10 according to the seventh non-limiting embodiment. FIGS. 3A and 3B are different perspective views of the molded article 10.

FIG. 3C depicts the molded article 10 according to the eight non-limiting embodiment. FIG. 3C depicts the molded article in a cross sectional view. In this view, it is seen that the hollow insert 100 defines a passageway 101 configured to convey a fluid. The fluid may be compatible with the hollow insert 100. The choice for the material for the hollow insert 100 may be done such that the compatibility with the injected alloy molding material and the cooling media is ensured. Also, the dimensioning is done such that the injection speeds, pressures and temperatures may be accommodated.

According to a variant, the fluid: (i) includes a coolant, and the coolant is compatible with the hollow insert 100, (ii) is configured to exchange heat, at least in part, with the body 60, and/or (iii) is configured to exchange heat, at least in part, with the body 60. By inserting a cooling/heating circuit into a magnesium component, a larger variety of applications may be accommodated and an increased level of complexity of the molded part may be achieved without significant change in the molding process. Examples of the article 10 include: (i) magnesium seat frames, (ii) automobile steering wheels, (iii) engine blocks, etc. According to other non-limiting variants, the hollow insert 100 permits weight reduction of the body 60, and/or the hollow insert 100 permits conveyance of a vacuum.

It will be appreciated that the fluid may be conveyed to and away from the interior of the hollow insert 100 while the mold is closed and clamped shut; if this arrangement is required, then the hollow insert 100 may be extended so that the insert 100 reaches outside of the mold (this arrangement is not depicted); how the fluid is conveyed to and away from the interior of the hollow insert 100 could be achieved by selecting an appropriate arrangement for connecting the fluid to the insert 100.

It will be appreciated that, under some cases, the insert 100 may be relatively fragile enough to require an internal, counter pressure during injection of the surrounding molten alloy molding material, and the timing of when the counter pressure is applied to and withdrawn from the interior of the insert 100 may be determined with some experimentation because otherwise the insert may rupture under excessive pressure during injection of the molten alloy. However, there may be cases where the insert 100 may be able to withstand the injection pressure associated with the molten alloy, and in these cases therefore the counter pressure during injection may not be required. An example of how pressurization of a part may be achieved is described in PCT Patent Application WO 2005/002825(A1).

The description of the non-limiting embodiments provides non-limiting examples of the present invention; these non-limiting examples do not limit the scope of the claims of the present invention. The non-limiting embodiments described are within the scope of the claims of the present invention. The non-limiting embodiments described above may be: (i) adapted, modified and/or enhanced, as may be expected by persons skilled in the art, for specific conditions and/or functions, without departing from the scope of the claims herein, and/or (ii) further extended to a variety of other applications without departing from the scope of the claims herein. It is to be understood that the non-limiting embodiments illustrate the aspects of the present invention. Reference herein to details and description of the non-limiting embodiments is not intended to limit the scope of the claims of the present invention. Other non-limiting embodiments, which may not have been described above, may be within the scope of the appended claims. It is understood that: (i) the scope of the present invention is limited by the claims, (ii) the claims themselves recite those features regarded as essential to the present invention, and (ii) preferable embodiments of the present invention are the subject of dependent claims. Therefore, what is to be protected by way of letters patent are limited only by the scope of the following claims:

What is claimed is:

1. A metal-molded article, comprising:
a body molded in association with a mold assembly; and
a hollow insert embedded, at least in part, in the body, the body having a light-metal alloy that was injected, under pressure, into the mold assembly.

2. The metal-molded article of claim 1, wherein:
the hollow insert defines a passageway configured to convey a fluid, the fluid being compatible with the hollow insert.

3. The metal-molded article of claim 1, wherein:
the hollow insert defines a passageway configured to convey a fluid, the fluid including:
a coolant being compatible with the hollow insert.

4. The metal-molded article of claim 1, wherein:
the hollow insert includes:
a tube.

5. The metal-molded article of claim 1, wherein:
the hollow insert includes:
a hollow core.

6. The metal-molded article of claim 1, wherein:
the hollow insert includes:
a network of tubes.

7. The metal-molded article of claim 1, wherein:
the light-metal alloy includes:
a magnesium alloy.

8. The metal-molded article of claim 1, wherein:
the hollow insert defines a passageway configured to convey a fluid, the fluid being configured to exchange heat, at least in part, with the body.

9. The metal-molded article of claim 1, wherein:
the hollow insert defines a passageway configured to convey a coolant, the coolant being configured to exchange heat, at least in part, with the body.

10. The metal-molded article of claim 1, wherein:
the hollow insert permits weight reduction of the body.

11. The metal-molded article of claim 1, wherein:
the hollow insert permits conveyance of a vacuum.

12. An injection metal-molding system configured to manufacture the metal-molded article of claim 1.

13. A metal-molding process for making a metal-molded article, the metal-molding process comprising:
a positioning operation, including positioning a hollow insert in a mold assembly being couplable with an injection metal-molding system;
a closing operation, including closing the mold assembly over the hollow insert at least in part; and
an injecting operation, including injecting a light-metal alloy into the mold assembly, the light-metal alloy surrounding, at least in part, the hollow insert, and the light-metal alloy forming into a body of the metal-molded article.

14. The metal-molding process of claim 13, wherein:
the hollow insert defines a passageway configured to convey a fluid, the fluid being compatible with the hollow insert.

15. The metal-molding process of claim 13, wherein:
the hollow insert defines a passageway configured to convey a fluid, the fluid including a coolant, the coolant being compatible with the hollow insert.

16. The metal-molding process of claim 13, wherein:
the hollow insert includes:
a tube.

17. The metal-molding process of claim 13, wherein:
the hollow insert includes:
a hollow core.

18. The metal-molding process of claim 13, wherein:
the hollow insert includes:
a network of tubes.

19. The metal-molding process of claim 13, wherein:
the light-metal alloy includes:
a magnesium alloy.

20. The metal-molding process of claim 13, wherein:
the hollow insert defines a passageway configured to convey a fluid, the fluid being configured to exchange heat, at least in part, with the body.

21. The metal-molding process of claim 13, wherein:
the hollow insert defines a passageway configured to convey a coolant, the coolant being configured to exchange heat, at least in part, with the body.

22. A mold assembly for molding a metal-molded article, the mold assembly comprising:
a mold portion, having:
a molding surface configured to mold, at least in part, a body; and
an insert locator configured to locate, at least in part, a hollow insert, the hollow insert to be embedded, at least in part, in the body, the body having a light-metal alloy that was injected, under pressure, into the mold assembly, the body and the hollow insert being combined to form the metal-molded article.
